(19) United States
(12) Patent Application Publication
(10) Pub. No.: US 2020/0311618 A1
(43) Pub. Date: Oct. 1, 2020

(54) MULTIMODAL NETWORK-BASED SERVICE

(71) Applicant: Uber Technologies, Inc., San Francisco, CA (US)

(72) Inventor: Maya Choksi Eichler, San Francisco, CA (US)

(21) Appl. No.: 16/365,553

(22) Filed: Mar. 26, 2019

(51) Int. Cl. G06Q 10/02; G06Q 10/06; G06Q 50/30; G01C 21/34; H04L 29/08

(52) U.S. Cl. CPC G06Q 10/02; G06Q 10/063114; H04L 67/12; G06Q 50/30; G01C 21/3438; G06Q 10/06316

(57) ABSTRACT

A network system is configured to manage and facilitate a multimodal network-based service. A user can interact with a user application executing on a user device to submit a service request to the network system. The network-based service can operate in a plurality of modes of operation, including at least a first mode in which individual entities manage the delivery of items and a second mode in which the network system manages the delivery of items. The network system can determine to dynamically modify the mode of operation for an individual service request.

### BACKGROUND

A user of a conventional network service can submit requests for one or more items provided by an entity to be delivered by a service provider to a service location. The user can do so via an application executing on a device of the user. Such a convention network service can operate only in a single mode of operation in which a service provider identified by the network service performs the task of delivering the requested items to the user.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example network system in communication with provider devices, user devices, and entities, in accordance with examples described herein;

FIG. 2A is a flow chart illustrating an example method of processing a service request for the network-based service in accordance with a first mode of operation, in accordance with examples described here;

FIG. 2B is a flow chart illustrating an example method of processing a service request for the network-based service in accordance with a second mode of operation, in accordance with examples described herein;

FIG. 3 is a flow chart illustrating an example method performed by a network system for automatically determining a mode of operation for a received service request, in accordance with examples described herein;

FIG. 4A is a flow chart illustrating an example method in modifying the mode of operation of the network-based service with respect to an existing service request, in accordance with examples described herein;

FIG. 4B is a flow chart illustrating an example of performing an automatic fallback to the second mode of operation for the network-based service for a given service request, in accordance with examples described herein; and

FIG. 5 is a block diagram that illustrates a computer system upon which examples described herein may be implemented.

### DETAILED DESCRIPTION

A network service, which is implemented by one or more servers or network computer systems (referred to herein as a “network system” for purposes of simplicity), is provided herein that enables a user to submit a service request for selected items to be delivered to a service location (e.g., the user's current location, a location selected or identified by the user, etc.). For a given entity and/or service request, the network service can operate in one of a plurality of modes of operation, including a first mode and a second mode. In the first mode, the given entity instructs drivers or couriers associated with the given entity (“entity providers”) to deliver the requested items to a requesting user. In the second mode, the network system can identify a service provider from a plurality of available service providers (e.g., not specifically associated with a given entity) to fulfill the service request.

According to embodiments, in the second mode of operation, the network system receives requests from users and links service providers (e.g., drivers, couriers, autonomous vehicles (AVs), etc.) with requesting users throughout a given geographic region (e.g., a metroplex such as the San Francisco Bay Area). In doing so, the network service communicates with a pool of service providers over the given geographic region, each operating a vehicle for providing services and one or more computing devices (“provider devices”). The network system receives requests for services (e.g., a transport service, a delivery service, etc.) from requesting users via a designated user or client application (“user application”) executing on the users' mobile computing devices (“user devices”). In response, the network system identifies one or more available service providers to fulfill each user's request. The network system can further determine a route for the identified service provider and transmit routing data to the provider device of the identified service provider to cause the provider device to display routing information (e.g., turn-by-turn navigation guidance) for the identified service provider. As described herein, user devices and provider devices can be computing devices such as smartphones, wearable devices, tablets, laptop computers, desktop computers, etc.

In one example, in the first mode of operation, the network system receives a request from a requesting user. Instead of identifying service providers associated with the network-based service to fulfill the requests, the entity associated with the request (e.g., entity(s) which is to provide items selected by the user) provides the entity providers with information regarding the delivery of the requested items. Entity providers can be drivers or couriers contracted to or hired by the entity. The entity can provide information such as the service location to the entity providers to enable the entity providers to deliver the requested items to the requesting users.

According to embodiments, various entities across a geographic region managed by the network system can operate in accordance with different modes of operation. For example, one entity can operate only in the first mode while another can operate only in the second mode. Furthermore, the mode of operation of the network-based service for a given entity can be dynamically adjusted. For instance, a first entity can operate by default in the first mode, but its mode of operation can be dynamically modified to the second mode, or vice versa.

According to embodiments, the mode of operation of the network-based service for a given entity can be dynamically modified based on data or a signal received from a computing device associated with the given entity (“entity computing device”). The entity computing device can be a desktop computer, laptop computer, tablet computer, telephone, payment terminal, and the like. The entity computing device can be located at the entity and/or be operated by an individual associated with the entity. In one example, the network-based service for the given entity operates (e.g., by default) in the first mode in which the given entity instructs entity providers to deliver requested items to requesting users and the network system is configured to not identify any service providers for service requests associated with the given entity. While operating in the first mode, the network system can receive a first service request from a first user. After receiving the first service request and while still operating in the first mode, the network system can receive a mode modification request (MMR) from the entity computing device at the given entity. The MMR can be a request to modify the mode of operation of the network-based service for the given entity from the first mode to the second mode. In response to receiving the MMR, the network system can operate in the second mode for any subsequent service requests received after receipt of the MMR (or any service requests received after a cut-off window (e.g., 5 minutes after receipt of MMR)). While operating in the second mode for these subsequent service requests associated with the given entity, the network system can identify service providers to fulfill these subsequent requests. In addition, the network system can continue to operate in the first mode for the first service request (and/or other requests received prior to the cut-off window (e.g., 5 minutes after the MMR was received)).

In some embodiments, in response to receiving a service request, the network system can automatically determine or select a mode of operation for a service request. The determination or selection can be made based on one or more parameters of the service request, based on real-time conditions of the given entity, and/or based on other contextual information (e.g., weather conditions, traffic, etc.). The network system can automatically select a mode of operation for a received service request based on one or more of: (i) an order queue at the given entity, (ii) item selection indicated by the service request, (iii) a service location indicated by the service request, (iv) a distance between the service location and the location of the given entity, (vi) a route for delivery of the items (e.g., route from entity location to service location), (v) availability of entity providers (e.g., pending requests to be fulfilled by entity providers, an available number of entity providers, etc.), (vii) estimated or actual wait times for requests associated with the given entity, (viii) weather conditions, (ix) traffic conditions, (x) a requested service time (e.g., a desired delivery time) or a time at which the service request was received, and/or (xi) a mode selection indicated by the service request (e.g., the user indicating, via the user application, a specific mode of operation). The rules and criteria for evaluating the various parameters to programmatically select the mode of operation can also be specified by the given entity (e.g., an operator at the entity can create customized rules in accordance to which the mode of operation of the network-based service with respect to the entity will be determined). The rules and criteria can also be determined by the network system based on machine-learning or can be specified by a system admin. In some examples, the rules and criteria can be specific to the given entity. In other examples, one or more of the rules and criteria can be specified for multiple entities.

In one example, the network system can automatically determine the mode of operation for a service request based on the service location indicated by the service request. For instance, service requests can be selectively processed in the first mode or in the second mode based on the distance between the service location and the location of the given entity. In this manner, the entity providers associated with the entity can perform deliveries within a predetermined distance or travel time (e.g., the first mode) and the network system can identify service providers to fulfill service requests having service locations outside the predetermined distance (or travel time) from the given entity. (e.g., the second mode). In an example, the network system can receive a service request associated with a given entity (e.g., a delivery order requesting items provided by the given entity to be delivered to the requesting user at a service location specified in the service request). In response to receiving the service request, the network system can automatically determine the mode of operation for the received request. The network system can determine to operate in the second mode to allow the network system to identify a suitable service provider based on the service location being determined to be located beyond a predetermined distance (e.g., 2 miles) from the location of the given entity. On the other hand, if the service location is determined to be located within the predetermined distance from the location of the given entity, the network system can determine to operate in the first mode for the service request. Conversely, as another example, the second mode of operation (e.g., utilizing service providers identified by the network system) can be automatically selected by the network system based on the service request having a service location within a predetermined distance (or travel time) of the entity and the first mode of operation (e.g., utilizing entity providers) can be automatically selected by the network system based on the service request having a service location beyond a predetermined distance (or travel time) of the entity.

In certain implementations, the network system can further automatically determine the mode of operation for the service request based on a requested service time (e.g., a delivery time indicated by the service request) or by the time at which the service request was received by the network system (e.g., if the service request indicates a delivery time of “as soon as possible”). In this manner, the entity (or the network system) can specify certain hours (e.g., late-night hours or early mornings when entity providers are unavailable) during which received service requests will be fulfilled by service providers identified by the network system (e.g., in the second mode); whereas, in other times (e.g., during regular business hours when entity providers are available), service requests will be fulfilled by entity providers.

In other examples, the network system can further automatically determine the mode of operation for a service request based on one or more parameters associated with the entity which is to provide the requested item(s). For instance, service requests can be selectively processed in the first mode or in the second mode based on an order queue for the entity. A real-time order queue for the entity can include information regarding all outstanding or pending orders associated with the entity. In some implementations, the order queue can include service requests received via the network-based service and orders received via other means (e.g., in person orders, telephone orders, orders via the entity's website, orders via a third-party network service, etc.). The order queue can be maintained by a computing system maintained by the entity (e.g., one or more payment terminals located at the entity, a server maintained by the entity, etc.) or can be maintained by the network system. In certain variations, the order queue can be maintained in part by the network system (e.g., service requests received via the network-based service) and in part by a computing system maintained by the entity (e.g., orders received via other means).

In more detail, according to an example, the network system can automatically determine a mode of operation for future service requests based on whether a number of pending orders in the order queue for the entity (or a subset thereof) is above or below a threshold count. For example, the network system can determine to operate in the first mode with respect to a service request received via the network-based service in response to determining that the number of pending orders in a subset of the order queue (e.g., orders for delivery in the first mode of operation) is below a threshold count. Conversely, the network system can determine to operate in the second mode with respect to a service request received via the network-based service in response to determining that the number of pending orders in the subset of the order queue (e.g., orders for delivery in the first mode of operation) is above the threshold count. In doing so, the network system can automatically determine to operate in the first mode of operation (in which entity providers fulfill the service requests) in response to determining that the number of pending orders for delivery by entity providers is below the threshold value or in the second mode of operation in response to determining that the number of pending orders for delivery by entity providers is above the threshold value. In this manner, the network system can selectively determine to operate in the first mode or in the second mode based on a real-time measure of demand for delivery service at the entity. The threshold count can be predetermined or preselected by an operator of the computing system of the entity or can be determined by the network system (e.g., using a machine-learned model, etc.). In other examples, the network system can determine to operate in the first mode or in the second mode based on other real-time measures of demand for delivery service at the entity (e.g., a wait time for customers, wait time at entity for entity couriers, etc.).

According to embodiments, an entity application executing on the entity computing system provides functionalities for the operator of the entity computing system to manage various aspects of existing orders (including service requests received via the network-based service) and/or incoming service requests. In one example, the entity application can display content corresponding to the order queue at the entity. The content can correspond to a list of pending orders received by the entity via the network-based service and/or via other means (e.g., in person orders, telephone orders, orders via the entity's website, orders via a third-party network service, etc.). The list of pending service requests can be displayed in a manner such that information corresponding to the operation mode for each of the pending order is displayed. For instance, each entry in the order queue can include information such as whether the order is an in-person order, a delivery order to be fulfilled by an entity provider (first mode), or a delivery order to be fulfilled by a service provider of the network-based service (second mode). In some examples, by interacting with the order queue, the operator of the entity computing system can alter the mode of operation of existing orders. In more examples, the operator, by interacting with the entity application, can enable or disable the network system from automatically determining a mode of operation of incoming service requests.

In a specific example of the above, the network system can receive a first service request associated with an entity from a first user device and determine to operate in the first mode with respect to the first service request. Subsequently, while the first service request is still pending (e.g., waiting to be prepared or being prepared), the network system can receive a second service request associated with the entity from a second user device. In response to receiving the second service request, the network system can determine to operate in the second mode with respect to the second service request (e.g., based on the real-time order queue at the time the second service request is received, based on the service location of the second service request, based on input received via the entity computing system, etc.). The network system can continue to operate in the first mode of operation with respect to the first service request while operating in the second mode of operation with respect to the second service request. In doing so, the network system can identify a service provider for the second service request and identify a route for the second service provider.

The network system can transmit data to the first user device to inform the first user that the first service request is being fulfilled in the first mode (e.g., via entity providers). In addition, the network system can transmit notification to the first user device that includes information regarding completion of a first task related to the first service request (e.g., preparation of the requested items) and information regarding a second task of the first service request (e.g., delivery of the items) not being provided by the network-based service but rather being provided by the entity (e.g., via entity providers). The network system can transmit data to the second user device to inform the second user that the second service request is fulfilled in the second mode (e.g., via service providers identified by the network system). The network system can further transmit notification to the second user device that includes information regarding completion of a first task related to the second service request (e.g., preparation of the requested items) and information regarding a second task of the second service request (e.g., delivery of the items) being provided by a service provider identified by the network system (e.g., identification information of the service provider, an estimated time of arrival of the service provider at the service location, etc.).

In certain implementations, whether and/or how an entity and its offering of available items are displayed within the user application executing on the user device can be based on the mode of operation of the entity. In certain implementations, optimizations can be performed to allow a single service provider identified by the network system to fulfill multiple service requests from multiple users. The network system can identify a pending first service request to be fulfilled in the near future (e.g., next twenty minutes) by a service provider and in response offer potential discounts for a user if the user submits a second service request for which the same service provider can be identified (e.g., based on the entity, the service route, the service locations of the first and second requests, the service time, etc.). These optimizations may only be available for entities processing incoming service requests in accordance with the second mode of operation (e.g., using service providers identified by the network system). Thus, such discounts and promotions tied to optimizations of utilizing the same service provider to fulfill multiple service requests may only be viewable within the user application if incoming service requests for a given entity is being processed in the second mode of operation.

Among other benefits, embodiments described herein provide for a network system that can operate in a plurality of modes of operation for received service requests. In comparison, existing network services are only known to operate in a single mode of operation. Accordingly, the network system described herein provide for additional functionalities as compared with an existing network system provisioning a conventional network service by incorporating new functionalities such as automatically determining a mode of operation for a given service request associated with a particular entity. By being able to automatically determine to operate either in the first mode or in the second mode, the network system can cause the requested service to be provisioned in accordance with the first mode of operation where appropriate (e.g., based on contextual information, real-time data, location data, etc.). In this manner, the network system can conserve processing and network resources in avoiding certain computationally intensive steps (such as identifying an optimal service provider, determining a route for the service provider, and providing real-time updates for the user) when operating in the first mode for the service request. As a result, the overall bandwidth of the system (e.g., in processing and managing service requests over a geographic region) can be increased. In other words, the number of service requests the network system can process and manage can be increased as a result of the improvements to the network system and other components of the distributed network architecture described herein.

In another aspect, the network system and the distributed network architecture described herein improve upon conventional network systems in being capable of dynamically and seamlessly transitioning between different modes of operation for a given entity based on various contextual information and real-time parameters (e.g., a number of requests in a request queue for the entity). In this manner, certain functions such as the automatic transitioning from operating in the first mode of operation to the second mode of operation, can be performed at optimal times and under the appropriate conditions based on the contextual information and real-time parameters. Such functionalities are not previously available with existing and conventional services. In particular, the unique distributed network architecture described herein comprising the network system, provider devices, user devices, and entity computing systems enables the such functionalities described herein and the improvement over existing and conventional services by the exchange of real-time information among the various components of the distributed network architecture.

As used herein, a computing device refers to devices corresponding to desktop computers, cellular devices or smartphones, personal digital assistants (PDAs), laptop computers, virtual reality (VR) or augmented reality (AR) headsets, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the network system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, VR or AR devices, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Descriptions

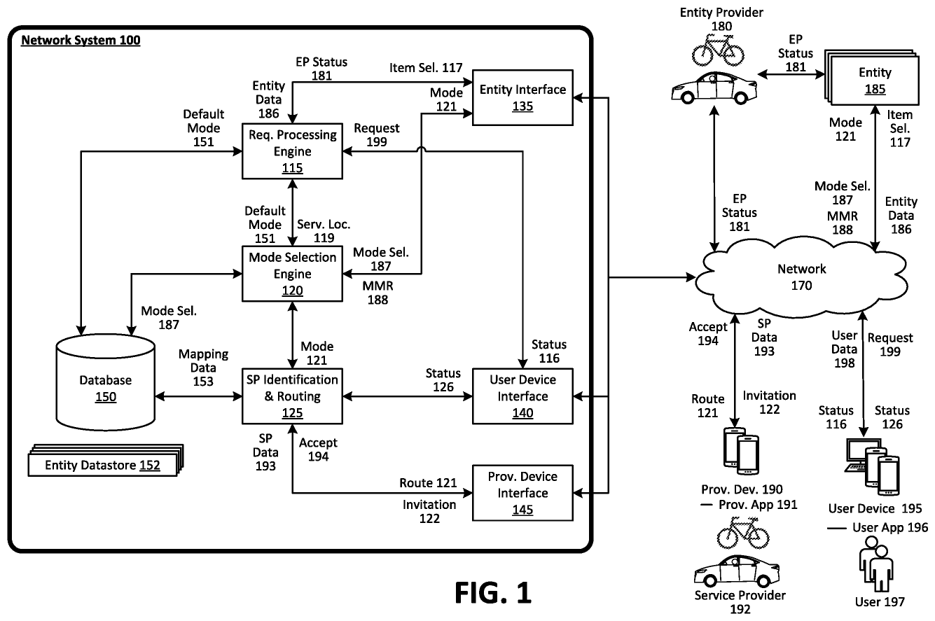

FIG. 1 is a block diagram illustrating an example network system in communication with provider devices, user devices, and entities, in accordance with examples described herein. The example network system 100 illustrated in FIG. 1 can implement or manage a network-based service (e.g., a delivery service, a courier service, etc.) that enables requesting users 197 to request items prepared or provided by one or more entities 185.

A requesting user 197 can submit a request 199 over the network 170 that indicates one or more selected items for delivery to a service location that can also be indicated by the request 199. The requesting user 197 can operate a user device 195 to execute a dedicated user application 196 for the network-based service and caused the user device 195 to transmit the request 199 via the user application 196. The user 197 can browse a plurality of items offered by one or more entities 185 to select one or more items for delivery to a service location. The service location can be automatically determined by the user device 195 based on data generated by one or more geo-aware resources of the user device 195 (e.g., GPS, GLONASS, Galileo, Beidou receivers, etc.) or can be entered manually by the user 197 via the user application 196. The network system 100, in response to receiving the request 199, can process the request 199 and transmit an item selection message 117 that indicates the one or more items selected by the user 197 to a relevant entity(s) 185 to enable the entity(s) 185 to provision or prepare the items requested by the requesting user 197.

The network system 100 can fulfill the request 199 in accordance with a plurality of modes of operation, including a first mode of operation and a second mode of operation. In the first mode of operation, the network system does not identify any service providers 192 (e.g., drivers, couriers, etc.) to fulfill the request 199. Instead, delivery of the items requested by the user 197 is performed by one or more entity providers 180 that are associated with the entity 185 that is to provide the requested items. The one or more entity providers 180 can be contracted to or hired by the entity 185.

According to embodiments, the network system 100 can include a request processing engine 115 that receives the request 199 from the user device 195 via the user device interface 140 and processes the received request 199. In response to receiving the request 199, the request processing engine 115 can parse the request 199 and transmit a selection of items requested by the user 197 to the entity 185 as item selection 117. The request processing engine 115 can retrieve information from a database 150 regarding the entity that is to provide the requested items (e.g., by querying an entity datastore maintained in the database 150). Such information can include a default mode of operation 151 for the entity. Some entities can opt to, by default, fulfill incoming service requests in accordance with the first mode of operation unless determined otherwise (e.g., based on order queue, etc.). Other entities can opt to, by default, fulfill incoming service requests in accordance with the second mode of operation.

The network system 100 can include a mode selection engine 120 to determine a mode of operation for the received service request. Such a determination can be based on the requested service time, the service location, pending orders in the order queue of the entity, etc. Once the mode of operation is determined for the service request, the determined mode 121 can be transmitted to the entity 185 via the entity interface 185 such that an entity application executing on the entity computing device can visually display the mode of operation for the service request.

The mode selection engine 120 can also receive data from the entity computing device corresponding to a mode selection 187. This can correspond to a change in the default mode of operation for the entity 185 for incoming service requests. In response to receiving the mode selection 187, the mode selection engine 120 can update the default mode of operation for the entity stored in the entity datastore 152 for the entity. The mode selection engine 120 can also receive a mode modification request 188 from the entity computing device. The mode modification request 188 can be correspond to a request to modify the mode of operation for a given service request, such as service request 199. The mode selection engine 120 can be configured to determine to accept or reject the mode modification request 188.

If the determined mode of operation is the first mode, the entity providers 180 can provide status updates (e.g., EP status 181) to the entity 185. In certain implementations, the status updates can be provided using a mobile computing device operated by the entity providers 180. For example, an entity provider 180 can transmit a communication EP status 181 indicating that delivery for a particular request 199 has been fulfilled. In response to receiving the EP status 181, a computer system at the entity 185 can transmit entity data 186 to inform the network system 100 that the requested service has been fulfilled. EP status 181 transmitted to the entity 185 can optionally include real-time status of the entity provider 180 (e.g., current location, etc.) such that real-time information regarding the entity provider 180 can be transmitted to the network system 100 and then relayed to the user 197 by the network system 100. In other implementations, the mobile computing device operated by the entity provider 180 can transmit EP status 181, over network 170, to the network system 100 instead of, or in addition to, the entity 185. In another example, the entity providers 180 can provide in-person status updates to the entity 185 (e.g., upon returning to the entity 185 after completing the requested service).

If the determined mode of operation is the second mode of operation, service provider identification and routing 125, in response to receiving the request 199, can identify one or more service providers 192 from a plurality of available service providers. The service provider 192 can be identified as a result of one or more optimization processes that identify service provider 192 as an optimal service provider based on various contextual parameters (e.g., entity's location, service provider's current location, traffic conditions, estimated time of arrival of the service provider at the entity location, preparation time for the requested items, current status of the service provider, etc.). For example, the network system 100 can estimate the time at which the requested items will be ready for pick-up for delivery to the requesting user 197. Such estimates can be computed or determined based on, for example, historical data associated with the entity 185 and/or the requested items, a measure of a real-time queue at the entity 185 (e.g., current order backlog including service requests for delivery and in-person orders), and the like. The network system 100 can identify a service provider 192 that, based on its current location and nearby traffic conditions, can arrive at or around the estimated time the requested items will be ready. The service provider identification and routing 125 can generate status updates 126 for transmission to the user device 195 to cause the user device to display information such as an estimated time of arrival of the service provider 192 at the service location.

The service provider identification process can further take into account factors such as the vehicle type of service provider 192, and the maximum payment of the service provider 192. For instance, the service provider and routing 125 can select service provider 192 based on its provider type that is determined to particularly suit the service location, entity location, and/or a route (or a portion thereof) determined by the network system 100 (e.g., route to the entity locations and to the service location). In an example, if the service location, entity locations, and/or the route are all located in a dense urban environment, the service provider identification and routing 125 can determine to select a service provider having a bicycle or motorcycle provider type. On the other hand, if the route includes a segment over a highway or an expressway, the service provider identification and routing 125 can identify a service provider having an automobile provider type. As another example, the network system 100 can determine that one or more routes between the entity 185 and the service location permit the operation of autonomous vehicles. In response, the network system 100 can identify an autonomous vehicle as service provider 192 to fulfill the request 199.

In response to identifying the service provider 192, the service provider identification and routing 125 can transmit an invitation 122 to a provider device 190 of the identified service provider 192. The provider device 190, executing a provider application 191, can display a notification or a prompt for the service provider 192. The provider 192 can accept or decline the invitation. Should the service provider 192 decline the invitation, the network system 100 can identify another service provider to fulfill the request 199. If the service provider 192 accepts the invitation 122, the provider device 190 can transmit an acceptance message 194 to the network system 100.

The service provider identification and routing 125 can continuously or periodically monitor the respective statuses of the service provider 192 and/or the entity 185 during the provision of the network-based service for the user 197. The network system 100 can continuously or periodically receive entity data 186 that indicates a current progress for preparation of the requested items. Similarly, the network system 100 can continuously or periodically receive service provider data 193 conveying the current location of the service provider 192. Based on monitoring the service provider 192 and/or the entity 185, the network system 100 can detect for events and determine whether to adjust any aspects of the network-based service in response. For example, the network system 100 can determine, based on the entity data 186 from the entity 185, that the entity 185 is experiencing delays in preparing the items requested by the user 197. The entity data 186 can indicate an updated estimated time at which the requested items will be ready for pick-up from the entity 185. In response to receiving the entity data 186, the network system 100 can determine whether to identify another service provider to fulfill the request 199. For example, if the entity data 186 indicates a significant delay in the preparation of the requested items, the network system 100 can determine to identify another service provider to fulfill the request 199 (e.g., a service provider who can be expected to arrive at the location of the entity 185 at or around the updated time at which the requested items are estimated to be ready for pick-up). As another example, if the service provider data 193 indicates that the service provider 192 is late in arriving at the location of the entity 185, the network system 100 can also determine to identify another service provider to fulfill the request.

### Methodology

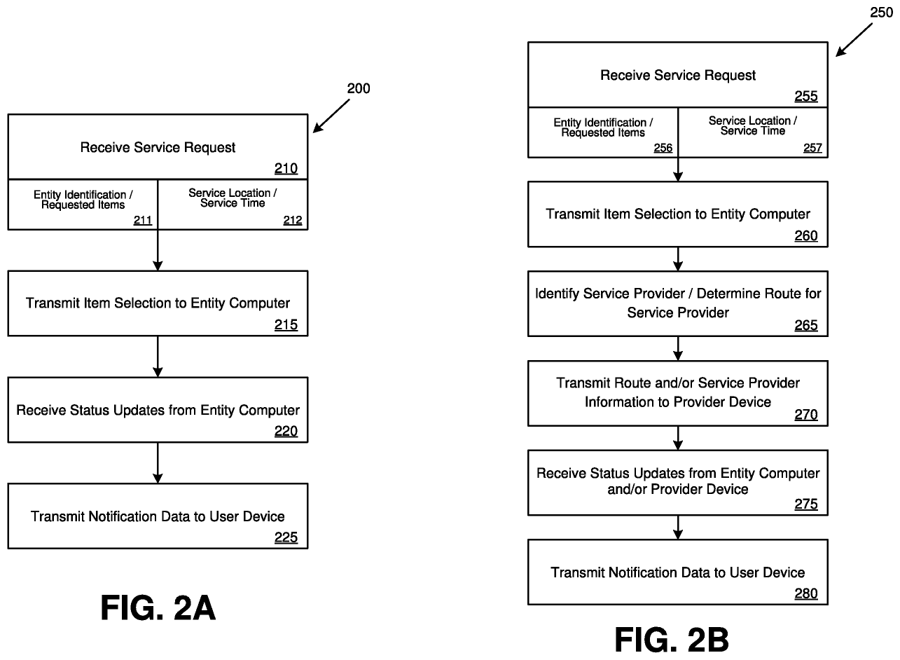

FIG. 2A is a flow chart illustrating an example method of processing a service request for the network-based service in accordance with a first mode of operation and FIG. 2B is a flow chart illustrating an example method of processing a service request for the network-based service in accordance with a second mode of operation, in accordance with examples described herein. In the below descriptions of FIGS. 2A and 2B, reference may be made to features and examples shown and described with respect to FIG. 1. For instance, the methods 200 and 250 shown in FIGS. 2A and 2B, respectively, may be performed by network system 100 illustrated in and described with respect to FIG. 1.

Turning to FIG. 2A, the network system operates in an example method 200 to process a received service request in the first mode of operation. The network system can receive a service request over a network from a user device (210). The requesting user can interact with his or her user device via a dedicated user application executing on the user device to generate and transmit the service request. The service request can include an identification of the requested item(s) for delivery and/or the entity that is to provide the requested items (211). For example, the user can launch the user application on the user device. With the user application, the user can view or scroll through a number of entities offering items for delivery in the vicinity of the service location and select one or more entities and one or more items for delivery. The service request can further indicate a service location and/or a desired service time (212). The service location (e.g., location at which an entity provider is to rendezvous with the requesting user to deliver the requested items) can be determined based on the current location of the user (e.g., based on location data generated by the user device) or can be inputted by the user via the user application. The service time (e.g., a time at which the entity providers to rendezvous with the requesting user to deliver the requested items) can be selected by the user to schedule a delivery in advance or can simply be an instruction to deliver the requested items as soon as they are ready.

The network system processes the service request and transmits the item selection to the entity computer system of the identified entity (215). The item selection can include an identification of the items selected by the requesting user and the service location. After receiving the item selection, the entity can begin preparing the item(s) selected by the requesting user. In doing so, the entity manages the preparation of the requested items and delivery of the requested items via one or more entity providers.

The network system can receive status updates from the entity computing system regarding the service request (220). As an example, data corresponding to a first status update indicating that the requested items have been picked up by an entity provider can be received by the network system. Such a status update can be generated by the operator of the entity computing system interacting with the entity application. For instance, the entity provider can select a “Order Picked Up” soft selection feature within the entity application. In response to the input, the entity computing device can transmit the data corresponding to the first status update to the network system. As another example, data corresponding to a second status update indicating that the order has been completed can be received by the network system. Such a status update can be similarly transmitted in response to an operator input via the entity application (e.g., an “Order Completed” soft selection feature). The operator can provide such an input, for example, when the entity provider returns from delivering the requested items or notifies the entity that delivery has been completed. In other examples, the entity provider can directly provide status updates to the network system via a dedicated application executing on a mobile computing device operated by the entity provider. For example, as illustrated in FIG. 1, the entity provider 180 can provide an entity provider status 181 to the network system 100 regarding a status (e.g., en-route to service location, ETA, etc.).

The network system can transmit notification data to the user device to cause the user device to display one or more notifications regarding the service request (225). One such notification can include information regarding a first task of the requested service (e.g., preparation of the items) being completed by the entity. Another notification can include information regarding the items being en-route to the service location (e.g., picked up by an entity provider). The notifications can also include one that informs the user that a second task of the requested service (e.g., delivery of the requested items) is not being provided for by the network-based service or service providers associated with the network-based service. The notification can inform the user that, rather, the second task of the requested service is being provided by entity providers or another third-party. In certain implementations where the entity provider operates a mobile computing device that communicates real-time updates to the network system (e.g., via entity provider status 181 in FIG. 1), the network system can also transmit such updates to the user device.

Turning to FIG. 2B, the network system can receive a service request (255). As described with respect to FIG. 2A, the service request can include an identification of the relevant entity and selected item(s) (256) and an indication of a service location and/or service time (257). Furthermore, as described with respect to FIG. 2A, the network system can transmit the selection of item(s) by the user to the entity computing device (260).

In various aspects, in the second mode of operation, the network system can identify or select a service provider from a plurality of service providers to fulfill the request for service and determine an optimal route for the identified service provider (260). In particular, service provider can be identified based on preparation times associated with the one or more selected items to, for example, minimize wait times for the selected service provider as well as the requesting user. For example, the network system can identify a service provider whose estimated time of arrival (based on a route determined for the service provider to the entity location) is at or around the time at which the requested items are estimated to be ready. The network system can additionally optimize the route to reduce travel distance and/or time. In addition, the network system can receive real-time data from entities to update the optimal route. For example, based on real-time data indicating delays at one particular entity, the network system can re-identify a service provider for the service request (e.g., in response to a delay, the network system can identify another service provider who is more suitable for arriving at the entity location at a later time, to avoid making the originally-identified service provider wait at the entity location for the items) or update the route to account for the delays (e.g., re-order the order of entities visited by the service provider along a service route of the service provider). The network system can select a service provider located proximately to an entity and/or the service location. Additionally, the network system can select a service provider based on the optimal route. For instance, the network system can select a bicycle service provider based on the optimal route being within a dense urban environment. In contrast, if the optimal route includes one or more segments over a freeway or highway, the network system can select an automobile service provider. In addition, the network system can identify a service provider based on a service capacity associated therewith. For instance, the network system can determine a required service capacity based on items selected by requesting users in a group of service requests to be serviced by a single service provider. The network system can identify a service provider such that the service capacity of the service provider is sufficient in fulfilling the group of service requests.

The network system can transmit the determined route to the provider device (270). The route can cause the provider device to present a turn-by-turn navigation route on the display of the provider device. The route can include a plurality of route segments such as one from the current location of the service provider to the location of the entity and a second route segment from the location of the entity to the service location, etc. The network system can also transmit additional information to aid the service provider in fulfilling the service request. Such information can include an identification of the requesting user (e.g., so that the service provider can verify the delivery) and/or the requested items (e.g., so that the service provider can verify the items when picking them up at the entity location). The information transmitted to the provider device can also include specific delivery instructions such as a door code for the service location, an intersection, a landmark, etc.

During the provision of the requested service, the network system can receive updates from the entity computing system and/or the provider device (275). While a first task of the requested service (e.g., preparation of the requested items) is being performed, the network system can monitor for status updates from the entity computing system. This can be performed in similar fashion as described with respect to step 220 of FIG. 2. After the first task is completed and/or while a second task of the requested service (e.g., delivery of the requested items) is being performed, the network system can monitor for updates from the provider device of the service provider identified to fulfill the service. As an example, after receiving the service request, the network system can begin monitoring status updates from the entity computing system such that the notifications regarding updates of the first task of the requested service can be transmitted to the user device. The network system can, in response to receiving a status update from the entity computing system that indicates that the first task of the requested service is completed, transmit data to the provider device to cause the provider device to transmit real-time updates (e.g., location data) to the network system. Such updates can be processed by the network system and notifications regarding the second task of the requested service can be transmitted to the user device.

The network system can transmit notification data to the user device to cause the user device to display one or more notifications regarding the service request (225). One such notification can include information regarding a first task of the requested service (e.g., preparation of the items) being completed by the entity. Another notification can include information regarding the items being en-route to the service location (e.g., picked up by an entity provider).

The network system can transmit notification data to the user device to cause the user device to display one or more notifications regarding the service request (225). One such notification can include information regarding a first task of the requested service (e.g., preparation of the items) being completed by the entity. Another notification can include information regarding the items being en-route to the service location (e.g., picked up by an entity provider). Another notification can include a notification informing the user that a second task of the requested service (e.g., delivery of the requested items) is being provided by a service provider associated with the network-based service. The notification can also include identification information of the service provider (e.g., picture, name, license plate of a vehicle operated by the service provider). In addition, the notification can include an estimated time of arrival at the service location. The user can also view such information within the user application executing on the user device. Within the application, such information can be updated in real-time based on data received from the entity and/or the provider device.

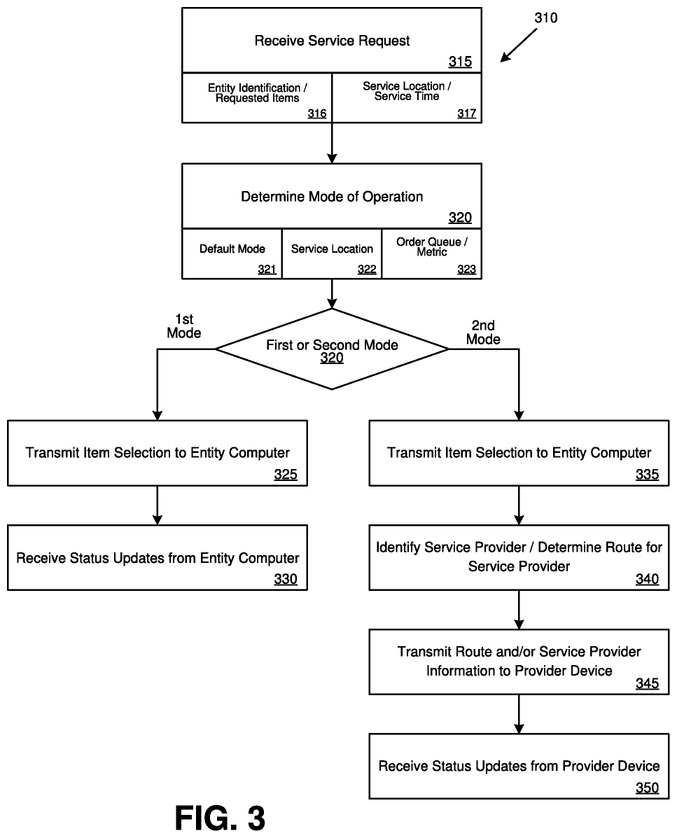

FIG. 3 is a flow chart illustrating an example method performed by a network system for automatically determining a mode of operation for a received service request, in accordance with examples described herein. In the below descriptions of FIG. 3, reference may be made to features and examples shown and described with respect to FIG. 1. For instance, the method 310 shown in FIG. 3 may be performed by network system 100 illustrated in and described with respect to FIG. 1.

Turning to FIG. 3, the network system receives a service request (315). As described with respect to FIG. 2A, the service request can include an identification of the relevant entity and selected item(s) (316) and an indication of a service location and/or service time (317). In response to receiving the service request, the network system can automatically determine a mode of operation for the received service request (320 and 325). This determination can be based on numerous factors, parameters, or variables. In one aspect, there can be a default mode selected with respect to the entity (321). The default mode can be selected by an entity operator (e.g., via entity application executing on an entity computing system). If a default mode is selected or set with respect to the entity, the network system can, by default, determine to operate in the selected default mode. For example, the network system can, by default, process all service requests in the first mode of operation unless one or more other conditions dictate otherwise. In this manner, the entity can select to utilize entity providers by default, rather than service providers, in fulfilling received service requests and fallback to the second mode of operation when entity providers are unavailable or occupied, or when the service location is too far for entity providers.

According to embodiments, the automatic determination of the mode of operation for the received service request can be further based on the service location of the request (322). For instance, a service request can be selectively processed in the first mode or in the second mode based on the distance between the service location indicated by the service request and the location of the given entity. In this manner, the entity providers associated with the entity can perform deliveries within a predetermined distance (e.g., the first mode) and the network system can identify service providers to fulfill service requests having service locations outside the predetermined distance from the given entity. (e.g., the second mode).

According to embodiments, the automatic determination of the mode of operation for the received service request can also be based on a real-time order queue maintained for the entity (323). The real-time order queue for the entity can include information regarding all outstanding or pending orders associated with the entity. In some implementations, the order queue can include service requests received via the network-based service and orders received via other means (e.g., in person orders, telephone orders, orders via the entity's website, orders via a third-party network service, etc.). The order queue can be maintained by a computing system maintained by the entity (e.g., one or more payment terminals located at the entity, a server maintained by the entity, etc.) or can be maintained by the network system. In certain variations, the order queue can be maintained in part by the network system (e.g., service requests received via the network-based service) and in part by a computing system maintained by the entity (e.g., orders received via other means).

The network system can be configured to automatically determine whether to operate in the first mode or in the second mode for the received request based on whether a number of pending orders in the order queue for the entity to be fulfilled in the first mode of operation is above or below a threshold count. For example, the network system can determine to operate in the first mode with respect to a service request received via the network-based service in response to determining that the number of pending orders in a subset of the order queue (e.g., orders for delivery in the first mode of operation) is below a threshold count. Conversely, the network system can determine to operate in the second mode with respect to a service request received via the network-based service in response to determining that the number of pending orders in the subset of the order queue (e.g., orders for delivery in the first mode of operation) is above the threshold count. In doing so, the network system can automatically determine to operate in the first mode of operation (in which entity providers fulfill the service requests) in response to determining that the number of pending orders for delivery by entity providers is below the threshold value or in the second mode of operation in response to determining that the number of pending orders for delivery by entity providers is above the threshold value.

Furthermore, the network system can be configured to automatically determine the mode of operation for the service request based on a requested service time (e.g., a delivery time indicated by the service request) or by the time at which the service request was received by the network system (e.g., if the service request indicates a delivery time of “as soon as possible”). In this manner, the entity (or the network system) can specify certain hours (e.g., late-night hours or early mornings when entity providers are unavailable) during which received service requests will be fulfilled by service providers identified by the network system (e.g., in the second mode); whereas, in other times (e.g., during regular business hours when entity providers are available), service requests will be fulfilled by entity providers.

If the network system determines to operate in the first mode, the network system can perform functions such as steps 325 (transmitting item selection to an entity computing system) and 330 (receiving status updates from entity computing system). These steps are described in more detail with respect to FIG. 2A (e.g., steps 215 and 220 of FIG. 2A). On the other hand, if the network system determines to operate in the second mode for the received service request, the network system can perform functions such as steps 335 (transmitting item selection to the entity computing system), 340 (identifying service provider), 345 (determining a route for the identified service provider), 350 (transmitting route data and/or service provider information to provider device), and 355 (receiving status updates from provider device). These steps are described in more detail with respect to FIG. 2B (e.g., steps 260 through 280).

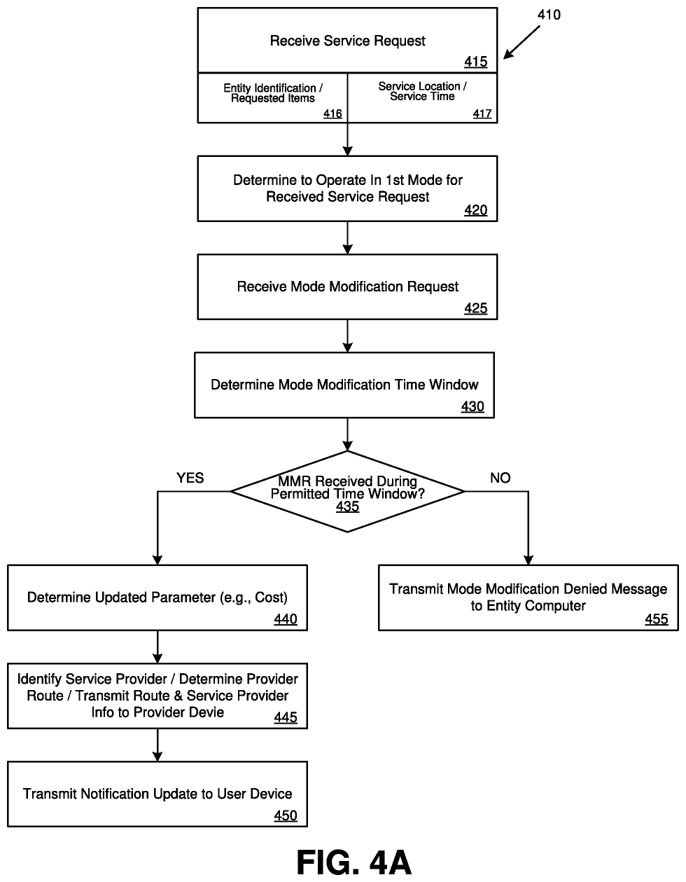

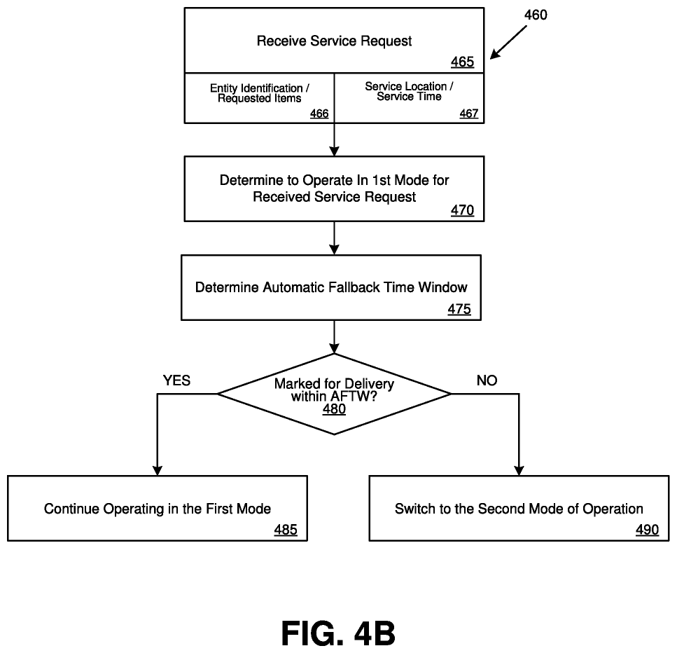

FIG. 4A is a flow chart illustrating an example method in modifying the mode of operation of the network-based service with respect to an existing service request, in accordance with examples described herein. FIG. 4A is a flow chart illustrating an example method in modifying the mode of operation of the network-based service with respect to an existing service request, in accordance with examples described herein. In the below descriptions of FIGS. 4A and 4B, reference may be made to features and examples shown and described with respect to FIG. 1. For instance, the method 410 and 460 shown in and described with respect to FIG. 4A and 4B, respectively, may be performed by network system 100 illustrated in and described with respect to FIG. 1.

Turning to FIG. 4A, the network system receives a service request (415). As described with respect to FIG. 2A, the service request can include an identification of the relevant entity and selected item(s) (416) and an indication of a service location and/or service time (417). In response to receiving the service request, the network system can determine to operate in the first mode of operation with respect to the received service request (420). Referring back to FIG. 3, the determination to operate in the first mode for the service request received at step 415 can be made in the same manner as step 320 illustrated in and described with respect to FIG. 3.

After determining to operate in the first mode of operation for the received service request (e.g., where one or more entity providers provide delivery of the items requested), the network system can receive a mode modification request (MMR) for the service request (425). The mode modification request can be transmitted by the entity computer in response to operator input via the entity application. The mode modification request can identify the specific service request by an identifier so that the network system can retrieve the appropriate request from the order queue of the entity.

In response to receiving the mode modification request, the network system can determine whether the mode modification request was received within the mode modification time window of the service request (430). The mode modification time window can specify an allowable time period during which the mode of operation of a given service request can be altered in response to a request from the entity. In other words, if the mode modification request is received during the mode modification time window, the network system can modify the mode of operation of the given service request. On the other hand, if the mode modification request is received outside the mode modification time window, the mode modification request can be declined.

In some implementations, the mode modification time window can be predetermined. In one example, the mode modification time window can be five minutes for all received service requests. In this example, at step 430, the network system can determine whether the mode modification request is received within five minutes of receiving the service request (step 420). In other examples, the mode modification time window can be dynamically determined based on the service request and other contextual information. For instance, the mode modification time window can be dynamically determined by the network system based on an estimated time of preparing the items requested by the user. Such item request preparation times can be estimated using machine-learning models generated using historical data relating to past service requests. As an alternative, the network system can receive real-time updates from the entity regarding the preparation of the requested items to estimate the time at which the requested items will be ready for pick up. The mode modification time window can also be dynamically determined by an estimated time of arrival of a service provider at the location of the entity to pick up the requested items. In this manner, the mode modification time window can be dynamically determined based on variables that can affect whether a service provider can be identified to arrive in time to pick up the requested items.

At step 435, the network system determines whether the mode modification request is received during the determined mode modification time window. If the mode modification request is received during the mode modification time window, the network system can determine updated parameters for the service request (440). The updated parameters can include a cost associated with providing the delivery service using service providers identified by the network system. In one example, in modifying the mode of operation of the service request in response to a request from the entity, the overall cost associated with the service request to the user can be maintained the same. In such a scenario, any costs directly associated with delivery paid by the user to the entity can be re-distributed to the network-based service as a result of the mode modification. In addition, the updated parameter indicating any additional cost associated with fulfilling the service request with the service provider identified by the entity can be computed. The additional cost can be paid by the entity to the network-based service in exchange for the mode modification.

At step 445, the network system can identify perform functions similar to those described with respect to steps 340 to 350 of FIG. 3. These steps can include the identification of a service provider, the determination of a route for the service provider, etc. At step 450, the network system transmits a notification to the user device informing the user that manner in which the user's service request is to be fulfilled has been modified. The notification can indicate information such as identification information of the service provider identified by the network system to fulfill the service request, an estimated time of arrival of the service provider at the service location, etc.

If the mode modification request was not received during the mode modification time window, the network system can transmit a mode modification denied message to the entity computing system (455) to inform the entity that the mode modification request was denied and that the entity is to arrange for the delivery of the requested items via one or more entity providers.

Turning to FIG. 4B, the network system receives a service request (465). As described with respect to FIG. 2A, the service request can include an identification of the relevant entity and selected item(s) (466) and an indication of a service location and/or service time (467). In response to receiving the service request, the network system can determine to operate in the first mode of operation with respect to the received service request (470). Referring back to FIG. 3, the determination to operate in the first mode for the service request received at step 465 can be made in the same manner as step 320 illustrated in and described with respect to FIG. 3.

According to embodiments, the network system can determine an automatic fallback time window (AFTW) for the service request (475). The automatic fallback time window can be a period of time defined for the service request operating in the first mode during which an entity operator can provide an input via the entity application executing on the entity device to indicate that the requested items have been picked up by an entity provider for delivery to the service location. Once the automatic fallback time window expires and the entity operator has not provided the input indicating that the requested items have been picked up by an entity provider for delivery to the service request, the network system can automatically cause a mode change for the service request (e.g., to the second mode of operation to identify one or more service providers to fulfill the requested service).

In some examples, the automatic fallback time window can be predetermined. For instance, the automatic fallback time window can be set at thirty minutes for all service requests received by the entity. In other examples, the automatic fallback time window can be determined based on an estimated preparation time of the items requested by the user. The estimation can be based on historical data (or a machine-learned model generated using the historical data) and contextual information such as the number of orders in the order queue of the entity. In yet more examples, the automatic fallback time window can be determined based on real-time status information received from the entity that indicates the status of preparation of the items requested by the user.

Once the automatic fallback time window expires, the network system can determine whether or not the requested items have been marked as having been picked up by one or more entity providers for delivery to the service location indicated by the service request (480). If so, the network-based service can continue to operate in the first mode for the given service request (485) (e.g., delivery provided by entity providers). If not, the network system can automatically cause the mode of operation for the service request to be modified from the first mode of operation to the second mode of operation (490). In doing so, the network system can identify a service provider, determine a route for the service provider, and notify the user of the modification in the mode of operation and the current status of the service request.

### Hardware Diagrams

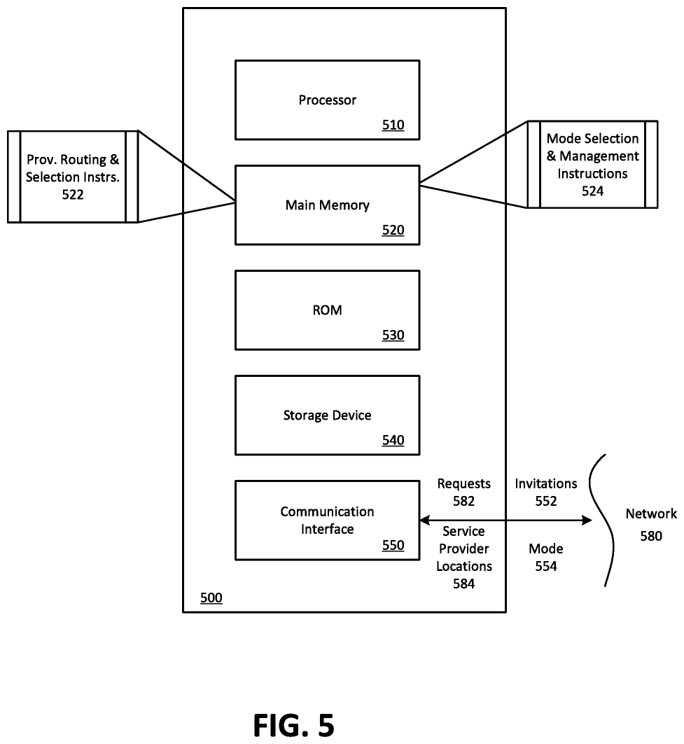

FIG. 5 is a block diagram that illustrates a computer system upon which examples described herein may be implemented. A computer system 500 can represent, for example, hardware for a server or combination of servers that may be implemented as part of a network service for providing on-demand services. In the context of FIG. 1, the network system 100 may be implemented using a computer system 500 or combination of multiple computer systems 500 as described by FIG. 5.

In one aspect, the computer system 500 includes processing resources (processor 510), a main memory 520, a memory 530, a storage device 540, and a communication interface 550. The computer system 500 includes at least one processor 510 for processing information stored in the main memory 520, such as provided by a random access memory (RAM) or other dynamic storage device, for storing information and instructions which are executable by the processor 510. The main memory 520 also may be used for storing temporary variables or other intermediate information during execution of instructions to be executed by the processor 510. The computer system 500 may also include the memory 530 or other static storage device for storing static information and instructions for the processor 510. A storage device 540, such as a magnetic disk or optical disk, is provided for storing information and instructions.

The communication interface 550 enables the computer system 500 to communicate with one or more networks 580 (e.g., a cellular network) through use of a network link (wireless or wired). Using the network link, the computer system 500 can communicate with one or more computing devices, one or more servers, and/or one or more self-driving vehicles. In accordance with some examples, the computer system 500 receives service requests from mobile computing devices of individual users. The executable instructions stored in the memory 530 can include service provider routing and selection instructions 522 and mode selection and management instructions 524 to perform one or more of the methods described herein when executed.

By way of example, the instructions and data stored in the memory 520 can be executed by the processor 510 to implement an example network system 100 of FIG. 1. In performing the operations, the processor 510 can process service requests and provider statuses and generate service invitations to facilitate fulfilling the service requests. The processor 510 executes instructions for the software and/or other logic to perform one or more processes, steps and other functions described with implementations, such as described by FIGS. 1 through 4B.

Examples described herein are related to the use of the computer system 500 for implementing the techniques described herein. According to one example, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

By performing the functions and techniques described herein, the computer system 500 is configured to receive requests 582 from user devices over the network 580 and identify appropriate service providers (e.g., based on service provider locations 584 received from provider devices over the network). The computer system can transmit invitations 552 to the identified service providers to invite the identified service providers to fulfill the requested service. In addition, the computer system 500 can generate notification data 554 to cause a user device to present a contextual notification that is specifically determined for the given user operating the user device.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A network system comprising:
one or more processors; and
one or more memory resources storing instructions that, when executed by the one or more processors of the network system, cause the network system to:
receive, over a network from a user device, a service request associated with an entity;
selecting a mode of operation for the service request from at least a first mode of operation and a second mode of operation based on one or more of: (i) a service request queue for the entity, or (ii) a service location indicated by the service request;
wherein, in response to selecting the second mode of operation for the service request, the network system is configured to identify a service provider for the service request from a plurality of service providers and transmit an invitation message to a provider device of the identified service provider; and
wherein, in response to selecting the first mode of operation for the service request, the network system is configured to not identify any service provider for the service request.

2. The network system of claim 1, wherein selecting the mode of operation for the service request comprises:
selecting the second mode of operation for the service request based on a number of requests in a subset of the service request queue being above a threshold count.

3. The network system of claim 2, wherein each request of the subset of the service request queue is identified as being associated with the first mode of operation.

4. The network system of claim 1, wherein selecting the mode of operation for the service request comprises:
selecting the second mode of operation based on a determined distance between the service location and a location of the entity being above a threshold value.

5. The network system of claim 1, wherein selecting the mode of operation for the service request is based further on a service time indicated by the service request.

6. The network system of claim 1, wherein the executed instructions further cause the network system to:
after selecting to operate in the first mode of operation for the service request, receive, from a computing device associated with the entity, a mode modification request for the service request;
in response to receiving the mode modification request for the service request, determine whether to modify the mode of operation for the service request to the second mode of operation;
in response to determining to modify the mode of operation for the service request to the second mode of operation:
identify the service provider for the service request from the plurality of service providers; and
transmit a set of content data to the user device to cause the user device to display information regarding a modification of the service request from the first mode of operation to the second mode of operation.

7. The network system of claim 6, wherein determining to modify the mode of operation for the service request to the second mode of operation comprises:
determining whether the mode modification request is received within a modification time window associated with the service request; and
determining to modify the mode of operation for the service request to the second mode of operation in response to determining that the mode modification request is received within the modification time window associated with the service request.

8. The network system of claim 6, wherein the executed instructions further cause the network system to:
determine, in response to determining to modify the mode of operation for the service request to the second mode of operation, an updated parameter associated with the service request.

9. The network system of claim 1, wherein the executed instructions further cause the network system to, after selecting either the first mode of operation or the second mode of operation for the service request, transmit, over the network to the user device, information about completion of a first task associated with the service request.

10. The network system of claim 9, wherein the information about completion of the first task associated with the first service is transmitted to the user device in response to receiving, over the network from a computing device associated with the entity, data indicating completion of the first task.

11. The network system of claim 1, wherein the executed instructions further cause the network system to:
based on selecting the first mode of operation for the service request, transmit, over the network to the user device, indication of a second task associated with the service request not being provided by the network system.
based on selecting the second mode of operation for the service request, transmit, over the network to the user device, indication of a second task associated with the service request being provided by the service provider, wherein the indication includes an estimated time of arrival to the service location.

12. The network system of claim 1, wherein the executed instructions further cause the network system to:
transmit, over the network to a computing device associated with the entity, information relating to the selected mode of operation for the service request to cause the computing device associated with the entity to present content relating to the selected mode of operation for the service request.

13. The network system of claim 12, wherein the content relating to the selected mode of operation for the service request is presented as a part of content presented by the computing device associated with the entity relating to the service request queue for the entity.

14. A network system for managing a network-based service, comprising:
one or more processors; and
one or more memory resources storing instructions that, when executed by the one or more processors of the network system, cause the network system to:
receive, over a network from a first user device, first set of data corresponding to a request for a first service associated with an entity;
determine that, for the entity, the network system operates in a first mode of operation for the first service;
in response to receiving, over the network from a computing device associated with the entity, data indicating completion of a first task of the first service, transmit, over the network to the first user device, (i) information about completion of the first task of the first service, and (ii) indication of a second task of the first service not being provided by the network system;
subsequently, receive, over the network from a second user device, a second set of data corresponding to a request for a second service associated with the entity;
determine that, for the entity, the network system operates in a second mode of operation for providing the second service, the second mode being different than the first mode;
in response to determining to operate in the second mode of operation for the second service, identify a service provider to provide a second task of the second service; and
transmit, over the network to the second user device, (i) information about completion of a first task of the second service, and (ii) indication of a second task of the second service being provided by the service provider, wherein the indication includes an estimated time of arrival to a service location specified by the second set of data.

15. The network system of claim 14, wherein:
wherein determining that, for the entity, the network system operates in the first mode of operation for the first service is based on one or more of: (i) a first service location specified by the first set of data, (ii) a first service time specified by the first set of data, or (iii) a service request queue associated with the entity at a first time at which the first set of data is received by the network system; and
wherein determining that, for the entity, the network system operates in the second mode of operation for the second service is based on one or more of: (i) a second service location specified by the second set of data, (ii) a second service time specified by the second set of data, or (iii) a service request queue associated with the entity at a second time at which the second set of data is received by the network system.

16. The network system of claim 14, wherein the executed instructions further cause the network system to:
receive, over the network from a computing device associated with the entity, a mode modification request for the first service; and
in response to determining to receiving the mode modification request for the first service, (i) identify a second service provider to provide a second task of the first service, and (ii) transmit, over the network to the first user device, a second indication of a second task of the first service being provided by the second service provider, wherein the second indication includes an estimated time of arrival to a second service location specified by the first set of data.

17. The network system of claim 14, wherein the executed instructions further cause the network system to:
transmit a first set of content data to cause a computing device associated with the entity to present content relating to the first service being associated with the first mode of operation; and
transmit a second set of content data to cause the computing device associated with the entity to present content relating to the second service being associated with the second mode of operation.

18. The network system of claim 17, wherein the content relating to the first service being associated with the first mode of operation and the content relating to the second service being associated with the second mode of operation.

19. A computer-implemented method for managing a network-based service, the method being performed by a network system and comprising:
receiving, over a network from a first user device, first set of data corresponding to a request for a first service associated with an entity;
determining that, for the entity, the network system operates in a first mode of operation for the first service;
in response to receiving, over the network from a computing device associated with the entity, data indicating completion of a first task of the first service, transmitting, over the network to the first user device, (i) information about completion of the first task of the first service, and (ii) indication of a second task of the first service not being provided by the network system;
subsequently, receiving, over the network from a second user device, a second set of data corresponding to a request for a second service associated with the entity;
determining that, for the entity, the network system operates in a second mode of operation for providing the second service, the second mode being different than the first mode;
in response to determining to operate in the second mode of operation for the second service, identifying a service provider to provide a second task of the second service; and
transmitting, over the network to the second user device, (i) information about completion of a first task of the second service, and (ii) indication of a second task of the second service being provided by the service provider, wherein the indication includes an estimated time of arrival to a service location specified by the second set of data.

20. The computer-implemented method of claim 19, wherein:
wherein determining that, for the entity, the network system operates in the first mode of operation for the first service is based on one or more of: (i) a first service location specified by the first set of data, (ii) a first service time specified by the first set of data, or (iii) a service request queue associated with the entity at a first time at which the first set of data is received by the network system; and
wherein determining that, for the entity, the network system operates in the second mode of operation for the second service is based on one or more of: (i) a second service location specified by the second set of data, (ii) a second service time specified by the second set of data, or (iii) a service request queue associated with the entity at a second time at which the second set of data is received by the network system.
